(19) United States
(12) Patent Application Publication
(10) Pub. No.: US 2018/0353829 A1
(43) Pub. Date: Dec. 13, 2018

(54) GOLF SWING DEVICE

(71) Applicant: Erik Mark Herberth, Cornelius, NC (US)

(72) Inventor: Erik Mark Herberth, Cornelius, NC (US)

(21) Appl. No.: 15/619,788

(22) Filed: Jun. 12, 2017

(51) Int. Cl. A63B 69/36; G09B 19/00

(52) U.S. Cl. CPC A63B 69/3676; A63B 2071/0694; G09B 19/0038

(57) ABSTRACT

A golf swing device. The golf swing device includes an elongated base. A bearing bracket is disposed within the elongated base. The bearing bracket includes a plurality of bearings. A first sliding member slides along a longitudinal axis of the elongated base via the bearing bracket. An end plate is secured to a distal end of the first sliding member. The end plate includes a substantially flat front surface facing away from the elongated base.

### BACKGROUND OF THE INVENTION

The present invention relates to a golf swing device and, more particularly, to a golf swing device that produces a square takeaway and clubface in a golf swing.

The majority of people who play the game of golf swing the golf club out of position immediately in the takeaway. The golf club gets too far inside, too open, and too far behind the player. This leads to many other issues throughout the golf swing and poor results.

As can be seen, there is a need for a golf swing device that produces a square takeaway and clubface in a golf swing.

### SUMMARY OF THE INVENTION

In one aspect of the present invention, a golf swing device comprises: an elongated base; a bearing bracket comprising a plurality of bearings disposed within the elongated base; a first sliding member operable to slide along a longitudinal axis of the elongated base by the bearing bracket; and an end plate secured to a distal end of the first sliding member, wherein the end plate comprises a substantially flat front surface facing away from the elongated base.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a perspective view of an embodiment of the present invention in an extended position;

FIG. 3 is a perspective view of a spike of an embodiment of the present invention;

FIG. 4 is a detail perspective view of an embodiment of the present invention shown in use;

FIG. 5 is a detail perspective view of an embodiment of the present invention shown in use;

FIG. 6 is a top view of an embodiment of the present invention shown in use;

FIG. 7 is a top view of an embodiment of the present invention shown in use;

FIG. 8 is a top detail view of an embodiment of the present invention;

FIG. 9 is a top detail view of an embodiment of the present invention;

FIG. 10 is a top perspective view of an alternate embodiment of the present invention;

FIG. 11 is a top perspective view of an alternate embodiment of the present invention; and

FIG. 12 is a top view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a device to produce a square takeaway and clubface in a golf swing. By adding resistance and a system that has to be moved by the golfer, the club swings on a square path with a square clubface. Because the device is forcing the player into the proper position, the present invention also increases the proper muscle memory for the golfer.

The present invention includes a high strength lightweight, portable base attached on the bottom of the sliding member. The sliding member is free to move in and out on top of the base along bearings. At the end of the sliding member is a small face plate. The golfer pushes against the face plate with the golf club while the present invention is in use. A case or extrusion tube may cover and tie the piece together.

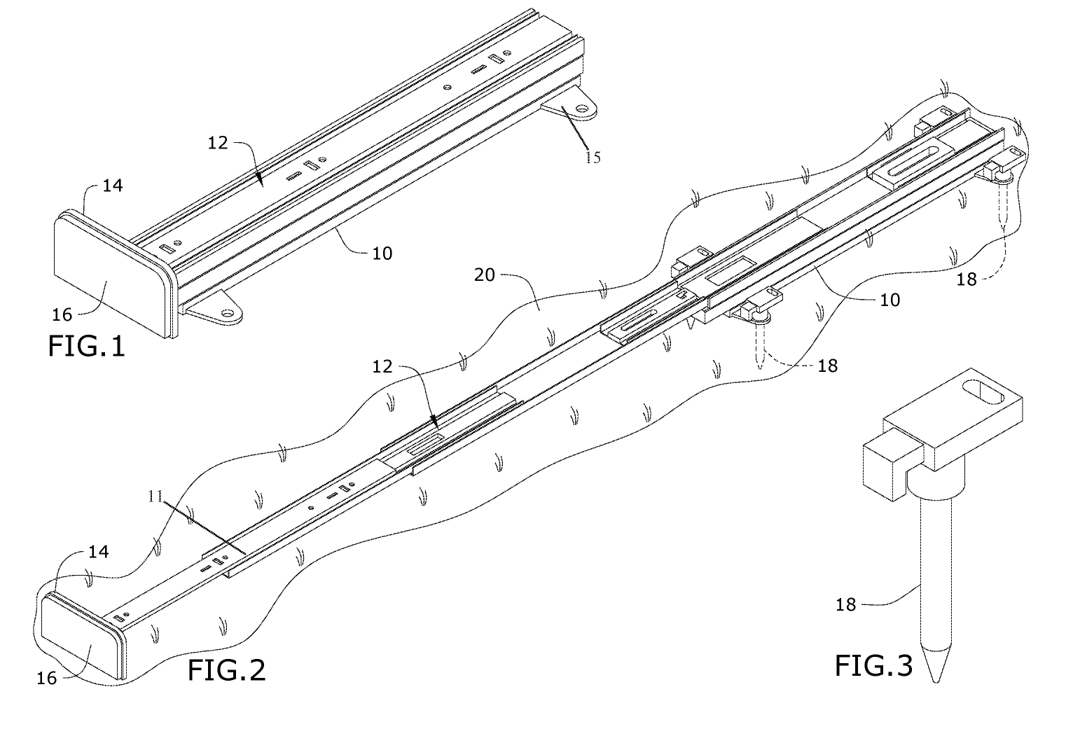

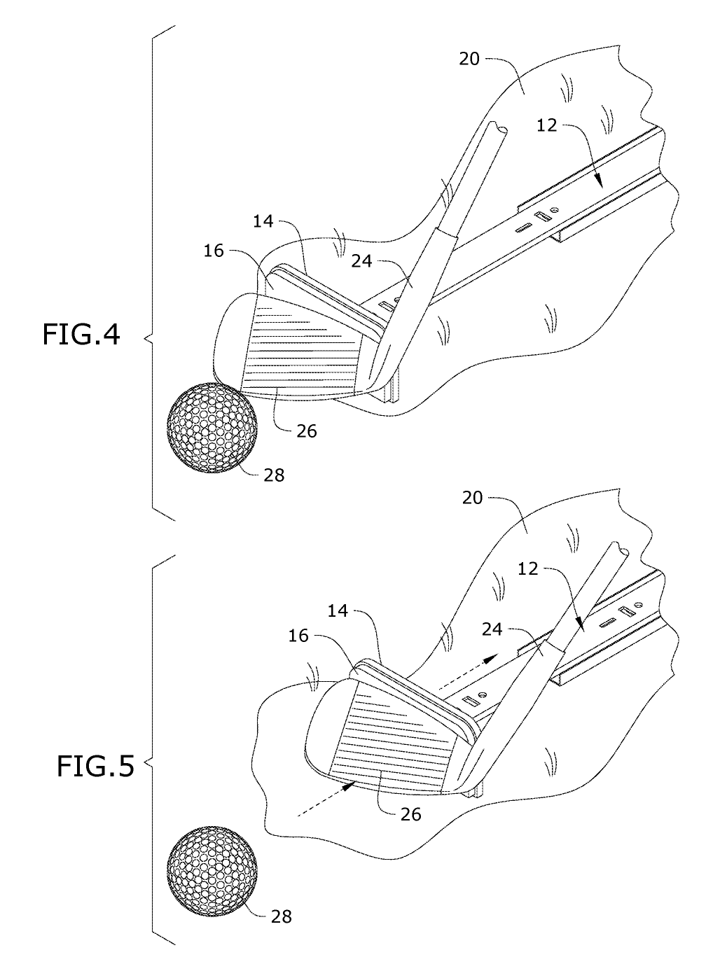

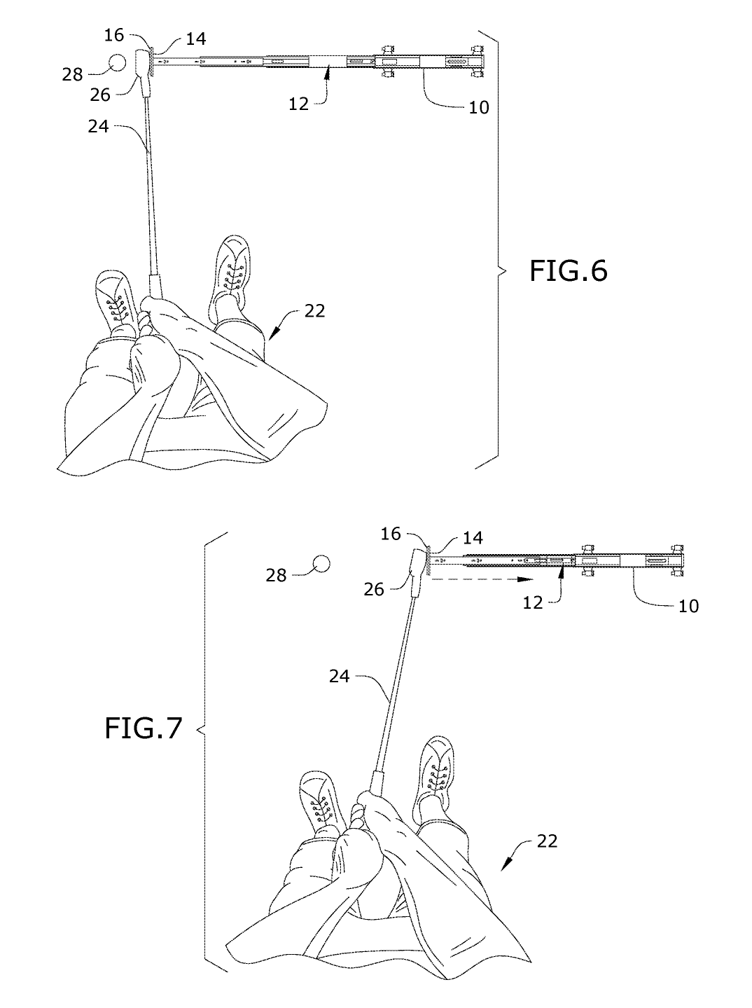

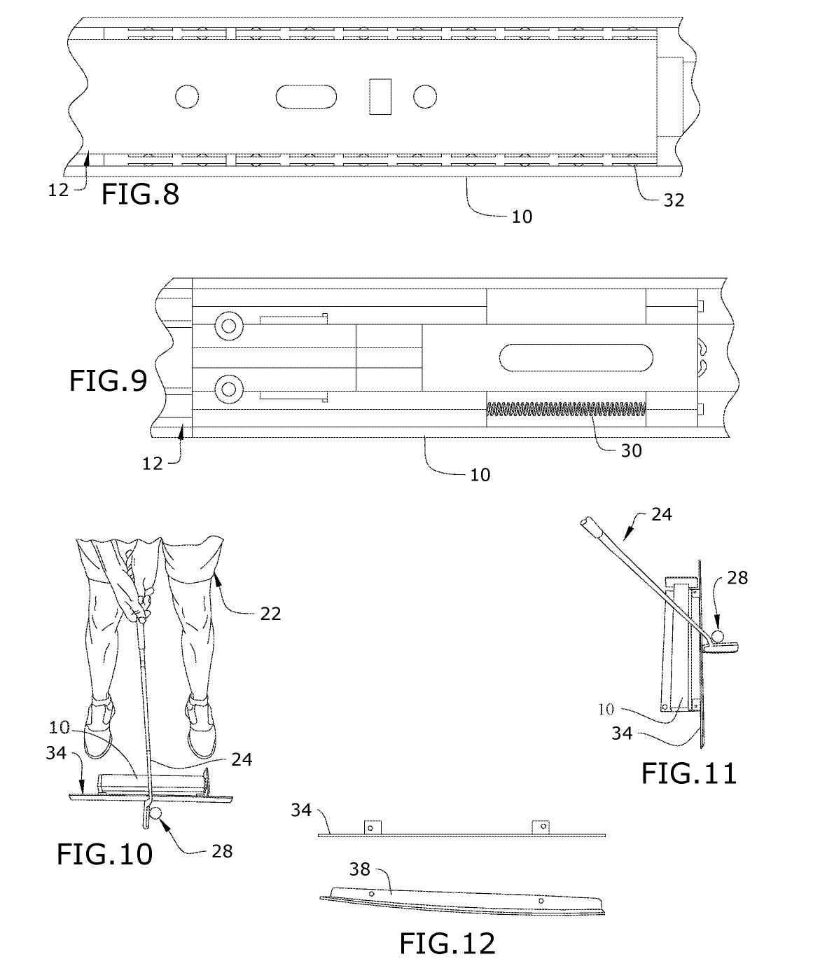

Referring to FIGS. 1 through 12, the present invention includes a golf swing device. The golf swing device includes an elongated base 10. A bearing bracket 32 is disposed within the elongated base 10. The bearing bracket 32 includes a plurality of bearings. A first sliding member 12 slides along a longitudinal axis of the elongated base 10 via the bearing bracket 32. An end plate 14 is secured to a distal end of the first sliding member. The end plate 14 includes a substantially flat front surface facing away from the elongated base 10.

The elongated base 10 includes a base plate and a pair of base sidewalls vertically extending from opposing sides of the base plate. The bearing bracket 32 is disposed in between the pair of base sidewalls. The bearing bracket may also include a pair of bracket sidewalls parallel to the pair of base sidewalls. The pair of bracket sidewalls each include a plurality of openings and a ball disposed within each of the openings forming the bearings.

In certain embodiments, the present invention may include a plurality of tabs 15 laterally extending from the base plate. Each of the tabs include an opening formed therethrough. The present invention may further include a plurality of spikes 18 each sized to fit through one of the openings of the tabs 15. The elongated base 10 may be placed on the ground and the spikes 18 may be driven through the openings of the tabs 15 and into the ground 20, thereby fixing the base to the ground 20. Each of the spikes 18 may include a hook that wraps around the tab 15 further securing the elongated base 10 to the ground 20.

The present invention may further include a compressible padding 16 secured to the substantially flat front surface of the end plate 14. The compressible padding may be an open or closed cell foam, silicone, rubber and the like. The padding 16 prevents a user 22 from damaging a golf club head 26 of a golf club 24 while using the device during a swing at a golf ball 28.

In certain embodiments, the present invention may further include a second sliding member 11. The second sliding member 11 is slidably engaged with the bearing bracket 32 along the longitudinal axis of the elongated base 10. In such embodiments, the present invention may further include a second bearing bracket 32 having a plurality of bearings. The second bearing bracket 32 is disposed within the second sliding member 11. The first sliding member 12 is slidably engaged with the second bearing bracket 32 along a longitudinal axis of the second bearing bracket 11. The first sliding member 11, the second sliding member 12 and the elongated base 10 form a telescoping device.

The present invention may further include a spring bracket 30 having springs. The springs are engaged with the sliding member 12 in a retracted position. The springs catch and insure that the unit fully closes out of the golfer's way. When engaged, the springs finish pulling the unit closed. The spring bracket also does not allow the unit to inadvertently open without the golfer doing so. The springs act as a latch to close, and keep the unit closed.

The present invention may further include a first attachment 34 and a second attachment 38. The first and second attachment 34, 38 may be placed against the elongated base and may be used to for putting alignment. Each of the first and second attachments 34, 38 include a flange that fits underneath the elongated bade 10 and a guide plate extending perpendicular from the flange. The guide plate guides the head 26 of the putter. The guide plate of the first attachment 34 may be substantially straight and the guide plate of the second attachment 38 may curve.

A method of using the present invention may include the following. Getting the club open and inside leads to nonsolid contact and offline shots. The golfer sets the device on the ground behind the ball in line with the intended target. The golfer tees up a ball directly in front of the face plate. The golf club goes in between the ball and the face plate. From there, the golfer makes their normal swing. The golfer thereby pushes against the face plate during the back swing and the sliding member slides back into the base.

The benefits of the present invention included the following. First, the resistance of the device makes it very difficult for the golfer to make their backswing with their hands. The shoulders must get engaged in order to start the backswing. Second, because the device extends a substantial amount away from the golfer this give the golfer a perfectly square path to swing the golf club on for as long possible. The club will not be able to travel to far inside or outside. The device will allow them to take the golf club back straight. Third, the device will not allow the clubface to get open relative to the arc of the golf club. The present invention creates a square club face which leads to more consistent shots. Many golfers have to flip the golf club on the way through because of how open the club gets on the way back. This excess face rotation makes it very hard to time the shot correctly and hit a straight shot. The present invention minimizes club face rotation throughout the swing.

The present invention may further include putting accessories. The putting accessories are used to help solve the same issue, allowing the user to make a proper putting stroke with a square clubface. The putting accessories are one 24″ straight edge and 24″ arced putting attachment that sit securely in the holes on the base of the unit. This allows the golfer to rest the heel of the putter against the putting attachment to create the desired path, either straight or arced.

It should be understood, of course, that the foregoing relates to exemplary embodiments of the invention and that modifications may be made without departing from the spirit and scope of the invention as set forth in the following claims.

1. A golf swing device comprising:
an elongated base;
a plurality of spikes extending from a bottom portion of the elongated base;
a bearing bracket comprising a plurality of bearings disposed within the elongated base;
a first sliding member operable to slide along a longitudinal axis of the elongated base by the bearing bracket;
a spring bracket disposed within the elongated base and comprising a spring operable to retain the first sliding member in a closed position; and
an end plate secured to a distal end of the first sliding member, wherein the end plate comprises a substantially flat front surface facing away from the elongated base.

2. The golf swing device of claim 1, wherein the elongated base comprises a base plate and a pair of base sidewalls vertically extending from opposing sides of the base plate.

3. The golf swing device of claim 2, wherein the bearing bracket is disposed in between the pair of base sidewalls.

4. The golf swing device of claim 3, wherein the bearing bracket comprises a pair of bracket sidewalls parallel to the pair of base sidewalls, wherein the pair of bracket sidewalls each comprise a plurality of openings and a ball disposed within each of the openings.

5. The golf swing device of claim 2, further comprising a plurality of tabs laterally extending from the base plate, each of the tabs comprising an opening formed therethrough.

6. The golf swing device of claim 5, wherein the plurality of spikes are each sized to fit through one of the openings of the tabs.

7. The golf swing device of claim 1, further comprising a compressible padding secured to the substantially flat front surface of the end plate.

8. The golf swing device of claim 1, further comprising:
a second sliding member slidably engaged with the bearing bracket along the longitudinal axis of the elongated base; and
a second bearing bracket comprising a plurality of bearings disposed within the second sliding member, wherein
the first sliding member is slidably engaged with the second bearing bracket along a longitudinal axis of the second bearing bracket.
